(19) United States
(12) Patent Application Publication
(10) Pub. No.: US 2009/0124440 A1
(43) Pub. Date: May 14, 2009

(54) Gear changing mechanism for chain drive

(76) Inventor: Warren Milne, Toronto (CA)

Correspondence Address: Mirek A. Waraksa, 1707-145 Marlee Ave., Toronto, ON, M6B 3H3, CA

(21) Appl. No.: 11/984,124

(22) Filed: Nov. 14, 2007

(51) Int. Cl. F16H 63/02

(52) U.S. Cl. 474/80

(57) ABSTRACT

A gear changing mechanism is adapted to engage an endless chain in a chain drive. The mechanism includes a rotary shaft and a gear set located around the shaft. The gear set has a plurality of generally circular gears of different diameter adapted to mesh with the chain, and the gear set has a plurality of operating positions each corresponding to partial wrapping of the chain about a different one of the gears. Each gear is formed as a plurality of separate gear segments that align circumferentially to define the gear. The gear set also comprises a plurality of separately moveable supporting structures each of which has rigidly fixed thereto one gear segment from each of the gears. Mounting means are provided that mount each of the supporting structures to the shaft for rotation together with the shaft and for axial displacement along the shaft. Controls are provided that can axially displace the supporting structures in succession between one operating position and another as each of the supporting structures and the gear segments fixed thereto enter a zone of non-contact with the chain. During gear changes, the chain remains stationary and the gears are displaced relative to the chain.

### FIELD OF THE INVENTION

The invention relates generally to gear changing mechanisms that drive or are driven by an endless chain.

### DESCRIPTION OF THE PRIOR ART

The invention has specific but not exclusive application to chain drives associated with bicycles. A bicycle commonly has a large central drive gear mounted for rotation to the bicycle frame and rotated with pedals. An endless chain commonly couples that drive gear to a smaller driven gear that rotates with the rear wheel. To allow different gear ratios, for example, to accommodate cycling up a hill, the driven gear is often part of a gear set that comprises multiple gears of different diameter, all centered about the rotational axis of the wheel and spaced apart axially. A mechanism commonly referred to as a “derailleur” is often used to force the chain to skip from one gear to an adjacent gear in order to change gear ratios, and a spring-operated mechanism is provided to control slack.

Such chain drives have several shortcomings. First, the drive gear often operates in a different plane than the driven gear. This creates lateral forces that do not contribute to propulsion, reducing efficiency, and must be absorbed by the chain and gears. The arrangement also precludes changing gears under power since the chain is prone to jumping out of engagement with the driven gear.

### BRIEF SUMMARY OF THE INVENTION

In one aspect, the invention provides a gear changing mechanism adapted to engage an endless chain in a chain drive. The mechanism comprises a rotary shaft with a central rotational axis and a gear set mounted to the rotary shaft. The gear set comprises a plurality of generally circular gears adapted to mesh with the chain and having different diameters. Each gear is centered about and oriented perpendicular to the rotational axis, and each gear is formed as a plurality of separate gear segments that align circumferentially to define the gear. The gear changing mechanism comprises a plurality of operating positions in which the gear set engages the chain. These include one operating position in which one gear is partially wrapped by the chain and another operating position in which another gear is partially wrapped by the chain. The gear set also comprises a plurality of separately moveable supporting structures, and each supporting structure has rigidly fixed thereto one gear segment from each of the gears. Mounting means are provided to mount each supporting structure to the shaft for rotation together with the shaft about the rotational axis and for axial displacement along the shaft. Controllable means are provided for axially displacing the supporting structures in succession between the one operating position and the other operating position as each supporting structure and the gear segments fixed thereto enter a zone of non-contact with the chain.

Various aspects of the invention will be apparent from a description below of preferred embodiments and will be more specifically defined in the appended claims. As regards claim interpretation, it should be noted that the invention has been defined in terms of “gears” since such terminology is commonly used in respect of chain-operated transmission mechanisms, particularly those associated with bicycles. The gears in issue, however, can also be characterized as “sprockets” since they are specifically adapted to mesh with chains.

### DESCRIPTION OF THE DRAWINGS

The invention will be better understood with reference to drawings, in which:

FIG. 1 is a fragmented perspective view of a bicycle;

FIG. 2 is fragmented perspective view of a gearing changing mechanism comprised by the bicycle;

FIG. 3 is an elevational view of a gear set comprised by the gear changing mechanism;

FIG. 4 is section along lines 4-4 of FIG. 3 further detailing features of the gear set;

FIG. 5 is a fragmented cross-section of the area designated 5 in FIG. 4 detailing a detent mechanism associated with the gear set;

FIG. 6 is a side elevation showing an annular three-part flange associated with the gear set and various cam followers mounted to the flange;

FIG. 7a is a view along lines 7a-7a in FIG. 6 detailing a moveable cam follower mounted for operation on an outer face of the flange;

FIG. 7b along lines 7b-7b of FIG. 6 showing a stationary cam follower fixed to an opposing inner face of the flange and the relative position of upshift and downshift cams;

FIG. 8 is a view along lines 8-8 of FIG. 6 detailing a movable cam follower mounted for operation on the inner face of the flange;

FIG. 9 is a fragmented perspective view of the gear changing mechanism with a first part displaced axially during an upshift operation;

FIG. 10 is a side elevation of the annular flange and various cam followers corresponding to the view of FIG. 9;

FIG. 11 is a view along line 11-11 of FIG. 10 showing a cam follower set for engagement by an upshift cam;

FIG. 12 is a view along line 12 of FIG. 10 showing engagement of the upshift cam with a stationary cam follower;

FIG. 13 is a fragmented, exploded view of the three parts of the gear set;

FIGS. 14-19 schematically illustrate how the parts of the gear set are displaced during an upshift operation; and,

FIGS. 20-25 schematically illustrate how the parts of the gear set are displaced during a downshift operation.

### DESCRIPTION OF PREFERRED EMBODIMENTS

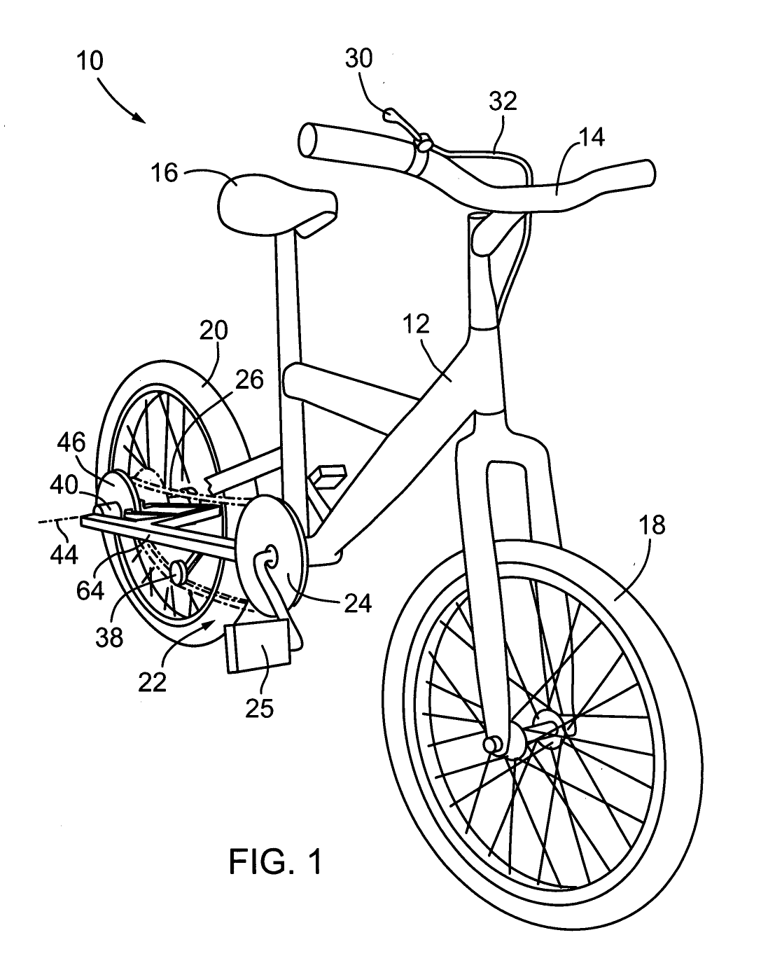

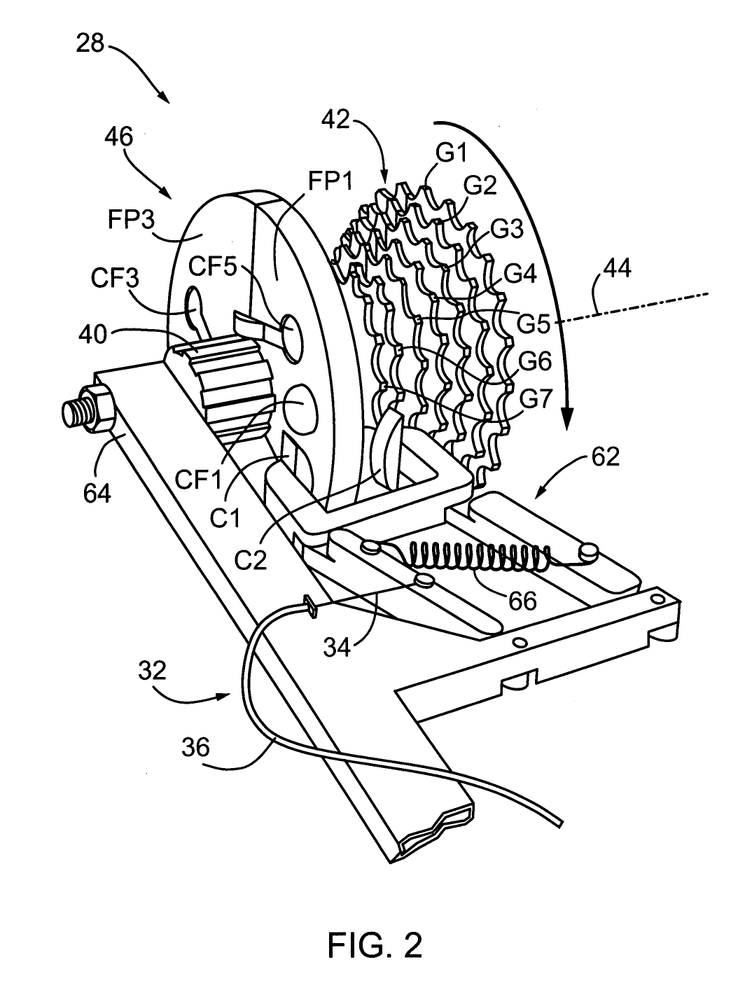

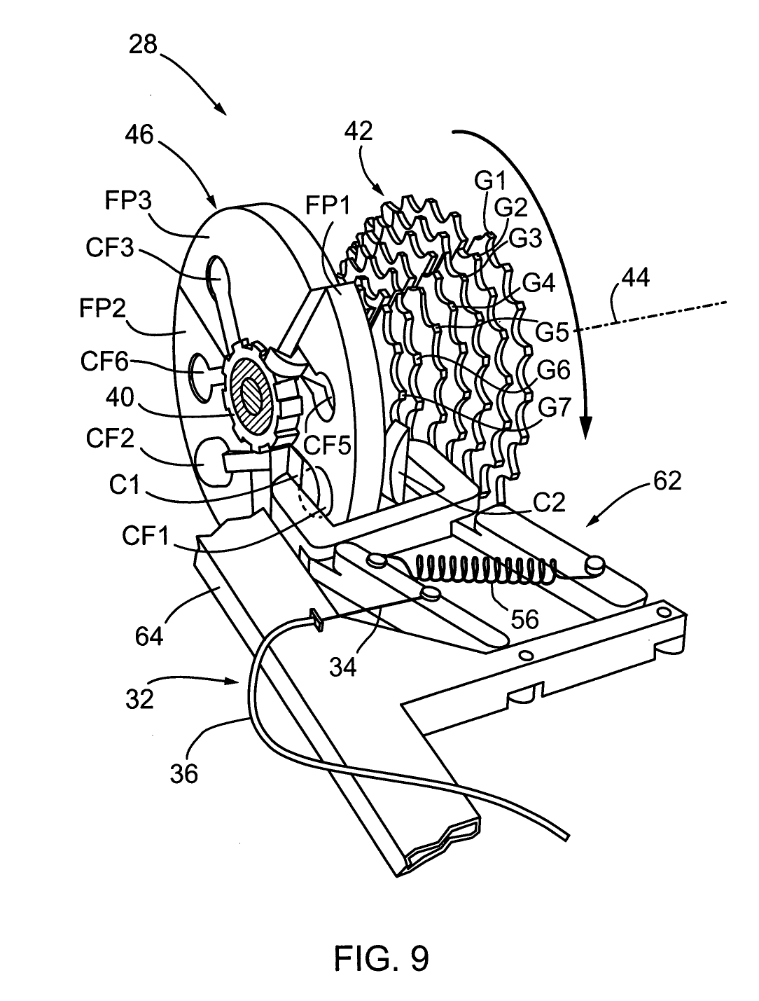

Reference is made to FIG. 1, which illustrates a bicycle 10 comprising a frame 12, a handlebar 14, a seat 16, front and rear wheels 18, 20, and a chain drive generally indicated with reference number 22. The chain drive 22 comprises a large central drive gear 24 mounted for rotation to the frame 12 and rotated with pedals 25. The drive gear 24 is coupled to the rear wheel 20 by an endless chain 26 and a gear changing mechanism 28 mounted to the frame for rotation with the rear wheel 20 and meshed with the chain 26. The gear changing mechanism 28 is operated with a conventional shift lever 30 mounted to the handlebar 14 and connected to the gear changing mechanism 28 by a Bowden cable 32 comprising a central wire 34 surrounded by a sheath 36 (detailed in FIGS. 2 and 9). A conventional slack uptake mechanism 38, which includes spring-biased gears, engages the chain 26 to ensure that the chain 26 remains properly tensioned. Except for the gear changing mechanism 28, the components of the bicycle 10 are well known in the art and are consequently not shown in detail in the drawings.

The gear changing mechanism 28 comprises a rotary spline shaft 40 that rotates with the rear wheel 20 and a gear set 42 mounted to the spline shaft 40, as apparent in FIGS. 2 and 9. The spline shaft 40 has a central lengthwise rotational axis 44 and is bearing mounted to the frame for rotation about the rotational axis 44. The gear set 42 comprises seven circular gears G1-G7 of different diameters. Each of the gears G1-G7 is centered about and oriented perpendicular to the rotational axis 44 of the shaft 40, and each of the gears G1-G7 is spaced a common distance A (indicated in FIG. 4) from any adjacent gear.

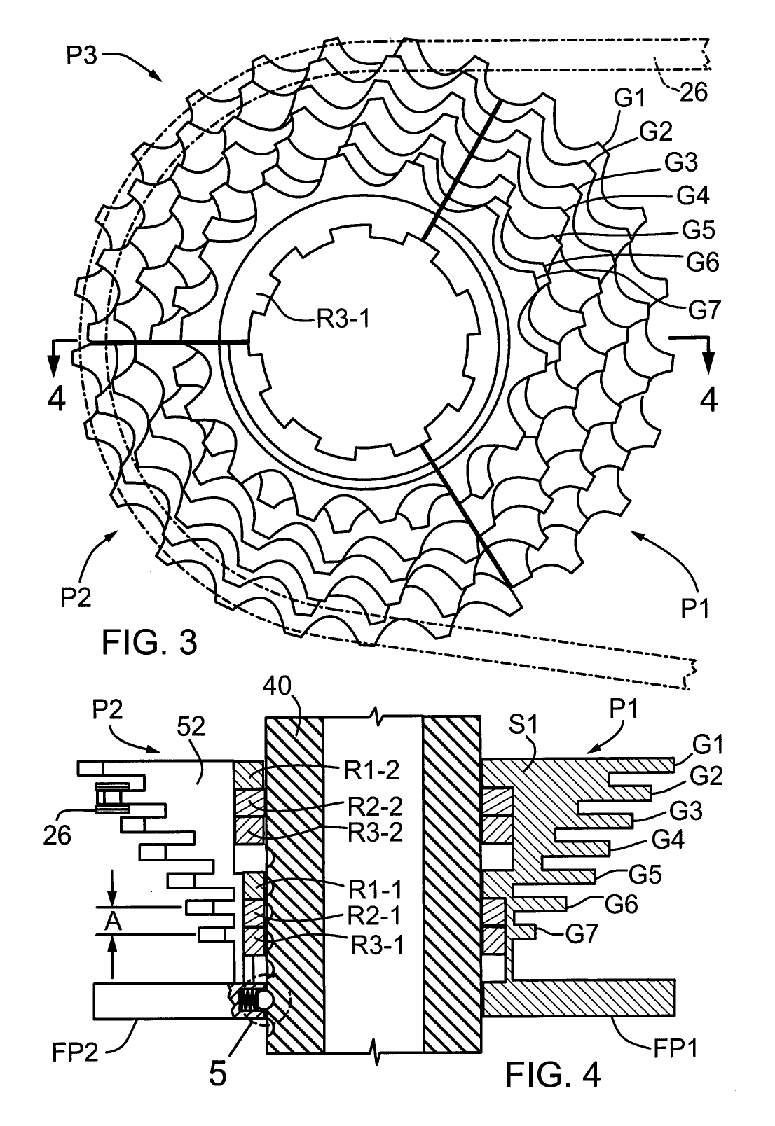

The gear set 42 has seven operating positions in which it can engage the chain 26. Each operating position corresponds to wrapping of the chain 26 partially about a different one of the gears G1-G7. One such operating position is apparent in FIG. 3 where the second largest gear G2 is partially wrapped by the chain 26. In accordance with the invention, the chain 26 undergoes no axial displacement relative to the frame but remains in a single plane while the gear set 42 moves axially relative to the frame to assume its different operating positions.

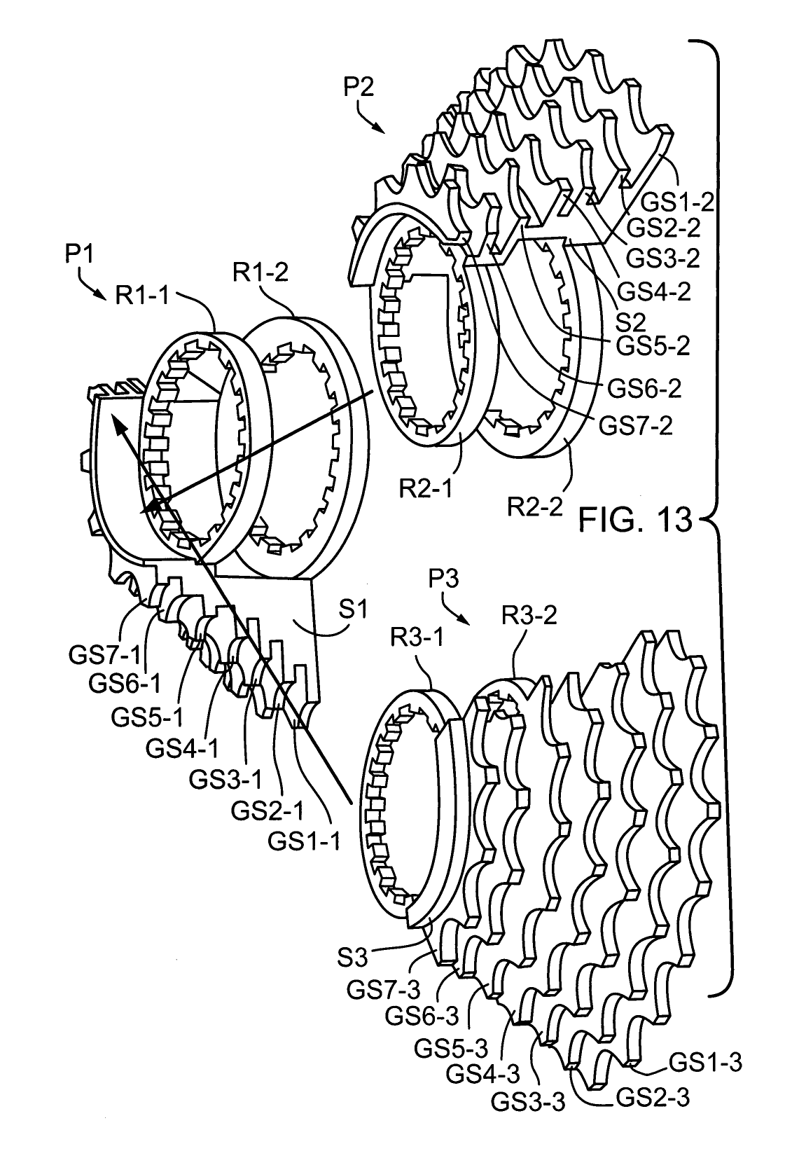

The gear set 42 has a three-part construction most apparent in the fragmented, exploded view of FIG. 13 and consisting of parts P1, P2 and P3. Each of the gears is constructed in three separate segments, and the gear G2, which is typical, may be seen in FIG. 13 to comprise three separate segments GS2-1, GS2-2 and GS2-3, which align circumferentially to define the gear G2 except when the gears G1-G7 are being shifted. The gear set 42 includes three separately moveable supporting structures S1, S2, S3 in circumferentially side-by-side relationship. Each supporting structure S1, S2 or S3 has a set of gear segments fixed thereto, the set consisting of one gear segment from each of the gears. For example, the supporting structure S1 associated with the part P1 carries gear segments GS1-1, GS2-1, GS3-1, GS4-1, GS5-1, GS6-1, and GS7-1, as indicated in FIG. 13, rigidly fixed thereto in parallel relationship with common spacing A. In a similar fashion, the part P2 carries gear segments GS1-2 to GS7-2, and part P3 carries gear segments GS1-3 to GS7-3. The gear set 42 includes an annular flange 46, which is apparent in FIGS. 2, 6, 9 and 10. The flange 46 has a three-part construction consisting of flange portions FP1-FP3, which are rigidly fixed respectively to parts P1-P3. Thus the part P1, which is typical, comprises the supporting structure S1, the flange portion FP1 and mounting rings discussed below, and carries gear segments GS1-1 to GS7-1. In preferred form, the principal components of each of the parts P1-P3 are integrally molded of titanium together with the carried gear segments.

The three parts P1-P3 are mounted to the spline shaft 40. To that end, each part P1, P2 or P3 includes a pair of mounting rings that locate about the spline shaft 40. These rings are shown in FIGS. 4 and 13 where the part P1 may be seen to comprise mounting rings R1-1 and R1-2; the part P2, mounting rings R2-1 and R2-2; and the part P3, mounting rings R3-1 and R3-2. The ring R3-1, which is typical, is detailed in FIG. 3 where it may be seen to comprise an internal cross-section in a plane perpendicular to the rotational axis 44 that consists of alternating axial grooves and ribs, complementary to the external cross-section of the spline shaft 40 and allowing part P1 and the spline shaft 40 to interlock axially. This arrangement forces the parts P1-P3 to rotate with the spline shaft 40 about the rotational axis 44 but permits axial displacement of the three parts P1-P3 relative to the shaft 40 to effect gear changes.

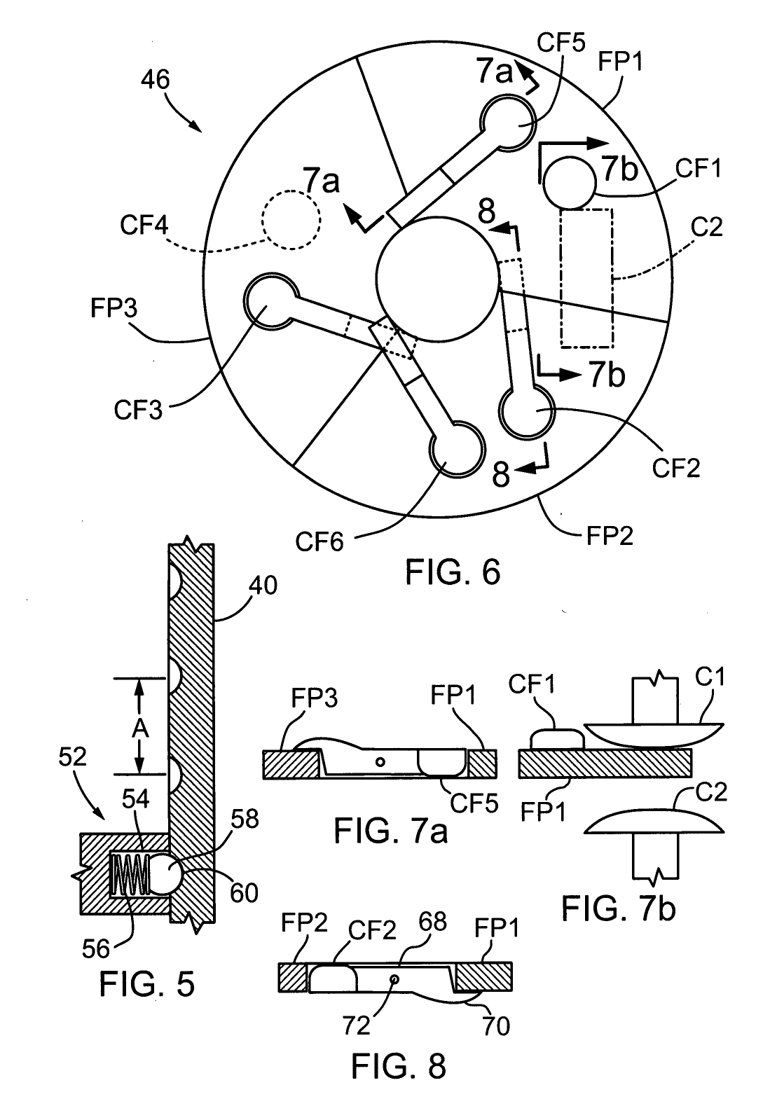

In this embodiment of the invention, the parts P1-P3 and the rotary shaft 40 are fitted with detent mechanisms that encourage the parts to locate in distinct axial positions relative to the chain 26. Each axial position corresponds to meshing of a different gear G1-G7 with the chain 26. FIG. 5 shows a typical detent mechanism 52, mounted in flange portion FP2. A passage 54 is formed in the flange portion FP2 and contains a spring 56 that forces a ball bearing 58 against the spline shaft 40. The exterior of the spline shaft 40 is formed with multiple part-spherical recesses shaped to receive the ball bearing, such as the recess 60 in FIG. 5 currently occupied by the bearing. There are seven such recesses (only 6 shown in FIG. 4 and only 4 in FIG. 5) corresponding to the seven distinct operating positions the gear set 42 can assume relative to the chain 26.

The shift lever 30 is coupled by the Bowden cable 32 to a parallelogram linkage 62 apparent in FIGS. 2 and 9. The linkage 62 is fastened to a wheel strut 64 and carries two cams C1, C2 used to displace the gear set 42 axially. An upshift cam C1 is positioned to engage structure associated with the outer face of the flange 46 during upshifting, and an opposing downshift cam C2 is positioned to engage structure associated with the inner face of the flange 46 during downshifting. With each shift of the shift lever 30, each of the cams C1, C2 displaces a distance corresponding to the common distance A between gears G1-G7. A biasing spring 66 normally urges the upshift cam C1 toward the outer face of the flange 46, and the downshift cam C2 away from the inner face.

The supporting structures S1-S3 are constrained to displace in a predetermined order from one operating position to another. This results from how the rings associated with the supporting structures S1-S3 are interleaved and will be apparent from FIG. 4. During an upshift to a smaller gear, the supporting structure S1 must displace first, then the supporting structure S2, and finally the supporting structure S3. Each of the supporting structures S1-S3 is free to displace only a distance A relative to the other supporting structures S1-S3 at which point the associated detent mechanism engages to resist further movement. The detent mechanisms are not strictly necessary as the part to be displaced cannot displace by more than distance A relative to the other parts, and during such displacement, the other parts are firmly engaged with the chain 26, which resists their axial displacement.

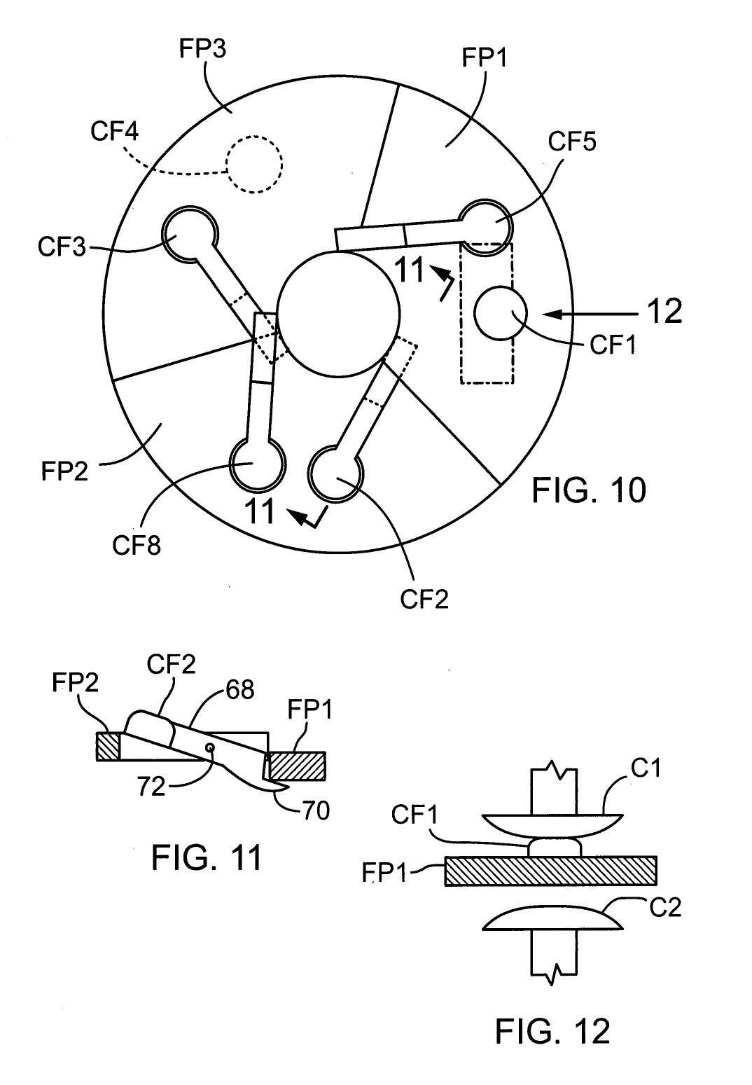

The displacement order during upshifting is effected by a system of cam followers both stationary and moveable. The supporting structure S1, the first to displace during an upshift, comprises a stationary cam follower CF1 fixed to its flange portion FP1 and extending distance A from the outer face of the flange 46. The cam follower CF1 is positioned to engage the upshift cam C1 as the gear set 42 rotates and the upshift cam C1 displaces toward the outer face of the flange 46. The succeeding supporting structures S2, S3 each comprise a movable cam follower CF2 or CF3 that must be set to an operating orientation to effect displacement of the associated supporting structure S2 or S3. The mounting of the cam follower CF2 of the supporting structure S2 is typical of all moveable cam followers incorporated into the gear set 42. It is mounted for movement between a retracted position (apparent in FIG. 8) within an aperture formed in the flange portion FP2 and an operative position (apparent in FIG. 11) in which the moveable cam follower CF2 is positioned to engage the upshift cam C1 during further rotation of the gear set 42. In its operative position, the moveable cam follower CF2 extends distance A from the outer face of the flange 46. The mounting means comprise a lever 68 located within the aperture, the lever 68 having one end fixed to the moveable cam follower CF2 and an opposing end that defines a lip 70 that engages the preceding supporting structure P1. A pivot pin 72 is anchored to the flange portion FP2 and extends through the lever 68 substantially midway between its opposing ends, supporting the lever 68 for pivoting movement relative to the flange portion FP2. What should be noted is that the moveable cam follower CF2 or CF3 on each succeeding supporting structure S2 or S3 is set to its operative position by relative axial displacement of the preceding supporting structure S1 or S2, respectively, and then reset when the succeeding supporting structure S1 or S2, respectively is displaced.

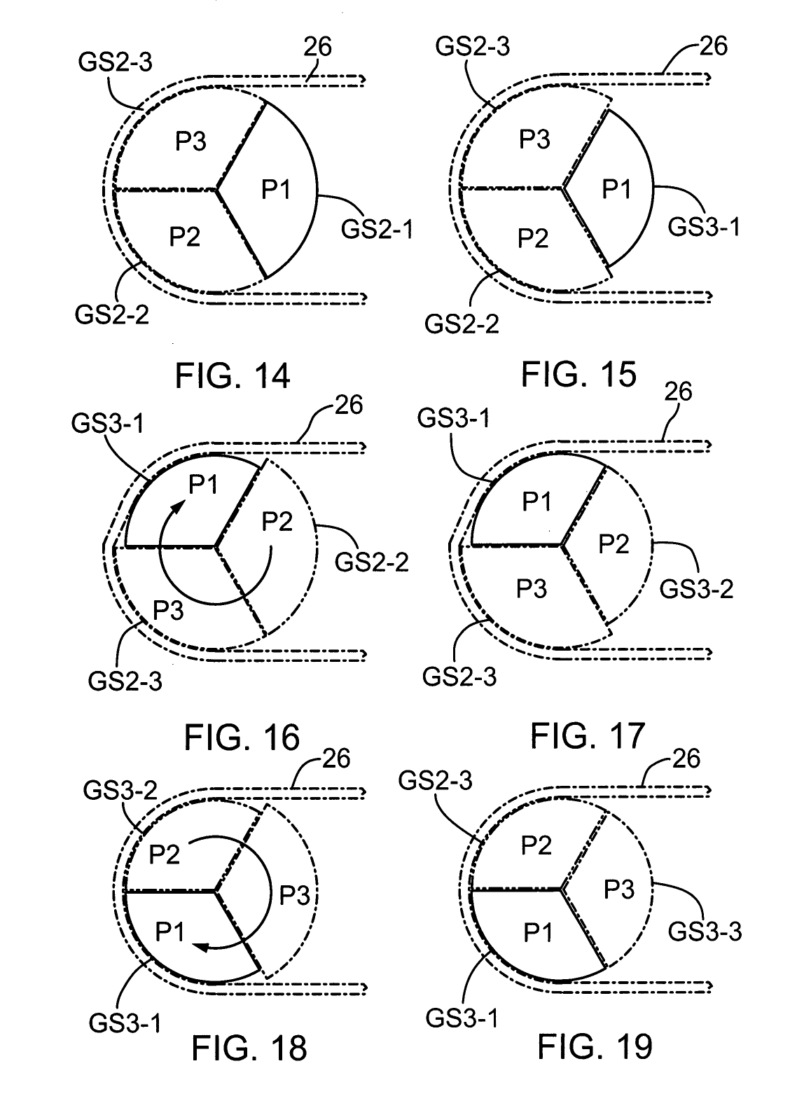

The upshift process will be described in greater detail with reference primarily to FIGS. 14-19. It is assumed that the chain 26 is initially partially wrapped about the second largest gear G2 as illustrated in FIG. 3 and that a transition will be made in which the chain 26 will partially wrap the smaller gear G3. First, the shift lever 30 is operated to displace the upshift cam C1 toward the outer face of the flange 46 substantially to the orientation apparent in FIG. 7b. As the gear set 42 rotates, the part P1 enters a zone of non-contact with the chain 26, as in FIG. 14. The upshift cam C1 then engages the stationary cam follower CF1 displacing the entirety of part P1 axially by the distance A. This places the gear segment GS3-1 attached to the part P1 within the plane of the chain 26, as apparent in FIG. 15. The axial displacement also sets the cam follower CF2 (as shown in FIG. 11), preparing the part P2 for similar axial displacement. (It is noted in passing that the displacement of part P1 incidentally sets cam follower CF5 on the inner face of the flange 46, as apparent in FIG. 9. However, this is inconsequential as the downshift cam C2 is then spaced by distance A from the inner face, as apparent in FIG. 12, and cannot engage the follower CF5) Further rotation of the gear set 42 through 120 degrees then meshes the gear segment GS3-1 with the chain 26.

With further rotation of the gear set 42, the part P2 eventually enters the zone of non-contact with the chain 26, as in FIG. 16. The upshift cam C1 then engages the set cam follower CF2, which forces the part P2 to displace axially. This positions the smaller gear segment GS3-2 within the plane of the chain 26, as apparent in FIG. 17. The axial displacement of the flange portion FP2 into a common plane with flange portion FP1 resets the moveable cam follower CF2 associated with the part P2, and sets the moveable cam follower CF3 of the part P3 in preparation for its axial displacement. (The cam follower CF6 at the inner face of the flange 46 is incidentally set but once again the downshift cam C2 is spaced from the inner face of the flange 46 and such setting is inconsequential.) With further rotation of the gear set 42, the part P3 enters the zone of non-contact, as in FIG. 18. The upshift cam C1 then engages the cam follower CF3, displacing the part P3 axially. This places the gear segment GS3-3 in the plane of the chain 26, as apparent in FIG. 19. Since all flange portions FP1-FP3 are now in a common plane, all moveable follower CF2, CF3, CF5 and CF6 are reset.

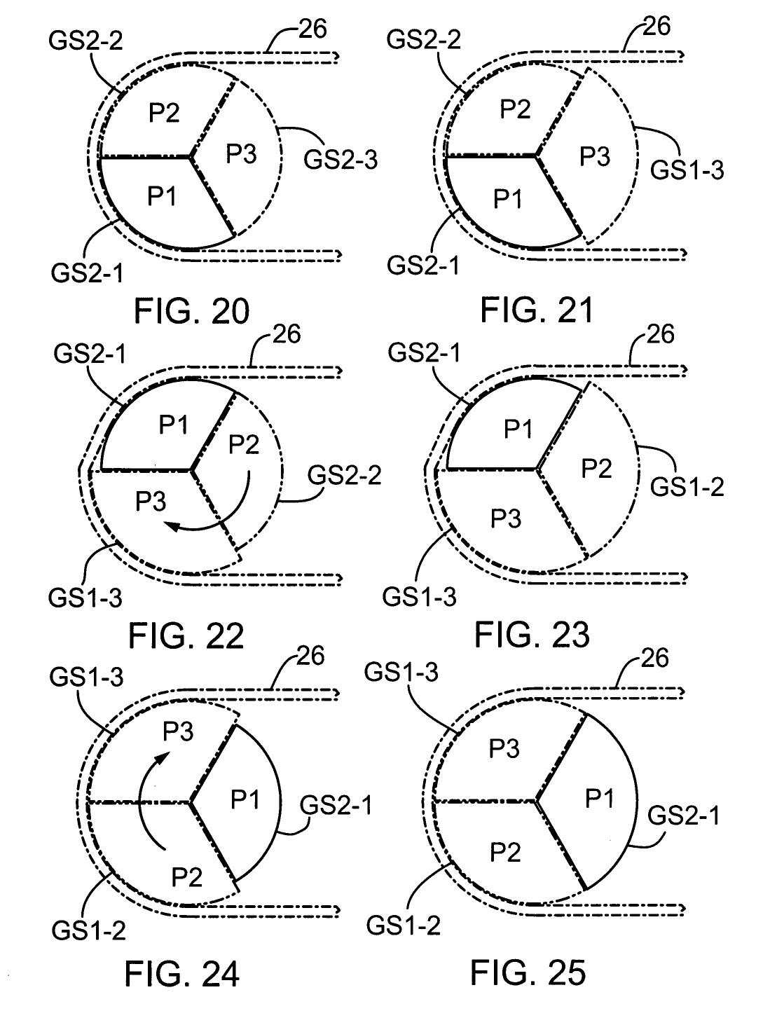

A downshift to a larger gear is essentially a reversal of the upshift process and will only be briefly described. It is assumed that a downshift will be initiated from gear G2 to the larger gear G1. During a downshift, the part P3 must displace first, then the part P2, and finally the part P1. The downshift is initiated with the shift lever 30, displacing the downshift cam C2 a distance A into proximity to the inner face of the flange 46 (not shown). When the part P3 enters the zone of non-contact, as in FIG. 20, the downshift cam C2 engages the stationary cam follower C4 of part P3 causing the part P3 to displace axially, as in FIG. 21, placing the gear segment GS1-3 in the plane of the chain 26. This also sets moveable cam follower CF6 in preparation for axial displacement of the part P2. With further rotation of the gear set 42, the part P2 enters the zone of non-contact, as in FIG. 22. The downshift cam C2 then engages the cam follower CF6 displacing the part P2 axially, as apparent in FIG. 23, placing the larger gear segment GS1-2 in the plane of the chain 26 and setting the moveable cam follower CF5 of the part P1. With further rotation of the gear set 42, the part P1 enters the zone of non-contact with the chain 26, as shown in FIG. 24. The downshift cam C2 then engages the cam follower CF5, displacing the part P1 axially as apparent in FIG. 25 until the gear segment GS3-1 is in the plane of the chain 26.

It will be appreciated that a particular embodiment of the invention has been described and illustrated and that modifications may be made without necessarily departing from the scope of the appended claims.

I claim:

1. A gear changing mechanism adapted to engage an endless chain in a chain drive, comprising:
a rotary shaft with a central rotational axis;
a gear set comprising:
(a) a plurality of generally circular gears adapted to mesh with the chain and having different diameters, each of the gears centered about and oriented perpendicular to the rotational axis, each of the gears formed as a plurality of separate gear segments that align circumferentially to define the gear,
(b) a plurality of operating positions in which the gear set engages the chain, the operating positions including one operating position in which one of the gears is partially wrapped by the chain and another operating position in which another of the gears is partially wrapped by the chain,
(c) a plurality of separately moveable supporting structures, each of the supporting structures having rigidly fixed thereto one gear segment from each of the gears, and
(d) mounting means mounting each of the supporting structures to the shaft for rotation together about the rotational axis and for axial displacement along the shaft; and,
controllable means for axially displacing the supporting structures in succession between the one operating position and the other operating position as each of the supporting structures and the gear segments fixed thereto enter a zone of non-contact with the chain.

2. The gear changing mechanism of claim 1 in which the mounting means comprise, for each of the supporting structures, one or more rings rigidly fixed to the supporting structure and surrounding the shaft.

3. The gear changing mechanism of claim 2 in which:
at least a portion of the shaft has a predetermined outer cross-section perpendicular to the rotational axis;
each of the rings comprised by the supporting structures comprises a predetermined inner cross-section perpendicular to the rotational axis; and,
the inner and outer cross-sections are selected such that each of the rings is interlocked with the shaft portion for rotation together about the rotational axis.

4. The gear changing mechanism of claim 2 in which:
the operating positions are spaced apart by a common axial distance; and,
the rings comprised by the supporting structures are interleaved such that, during the axial displacement between the one operating position and the other operating position, each of the supporting structures is constrained while in the zone of non-contact to displace axially by no more than the common axial distance.

5. The gear changing mechanism of claim 2 in which:
the rotary shaft comprises a plurality of longitudinal splines; and,
each of the rings comprises a plurality of longitudinal recesses each receiving a different one of the splines.

6. The gear changing mechanism of claim 1 comprising detent means acting between the supporting structures and the rotary shaft for resisting axial displacement of the supporting structures at predetermined axial positions along the rotary shaft, each of the predetermined axial positions corresponding to a different one of the operating positions of the gear set.

7. The gear changing mechanism of claim 1 in which:
the gear set comprises a circumferential flange with a pair of opposing faces centered about and oriented perpendicular to the rotational axis of the shaft;
the flange is defined by a plurality of separately moveable flange portions that align circumferentially to define the flange;
each of the flange portions is comprised by and rigidly fixed to a different one of the supporting structures; and,
the controllable means comprise a cam and means for displacing the cam toward the one face of the flange.

8. The gear changing mechanism of claim 7 in which:
the supporting structures are displaced in a predetermined order from the one operating position to the other operating position;
the first of the supporting structures to displace comprises a cam follower fixed to the flange portion of the supporting structure and positioned to engage the cam as the gear set rotates and the cam displaces toward the one face of the flange; and,
each succeeding one of the supporting structures to displace comprises:
(i) a moveable cam follower, and
(ii) follower mounting means mounting the moveable cam follower to the flange portion of the supporting structure for movement between a retracted position within the flange portion and an operative position in which the moveable cam follower is positioned to engage the cam as the gear set rotates and the cam displaces toward the one face of the flange, the follower mounting means engage the preceding one of the supporting structures such that displacement of the preceding supporting structure from the one operating position to the other operating position displaces the moveable cam follower to its operative position and subsequent displacement of the succeeding supporting structure from the one operating position to the other operating position returns the moveable cam follower to its retracted position.

9. The gear changing mechanism of claim 8 in which the follower mounting means of each of the succeeding supporting structures comprise:
a lever with a pair of opposing ends, one of the opposing ends fixed to the moveable cam follower of the supporting structure and the other of the opposing ends engaged with the preceding supporting structure; and,
a pivot pin engaging the lever intermediate its pair of opposing ends and supporting the lever for pivoting relative to the supporting structure.
